(19) United States
(12) Patent Application Publication
(10) Pub. No.: US 2026/0194920 A1
(43) Pub. Date: Jul. 9, 2026

(54) USING ARTIFICIAL INTELLIGENCE (AI) MODELS TO PREVENT SATELLITE COLLISIONS

(71) Applicant: International Buseness Machines Corporation, Armonk, NY (US)

(72) Inventors: Naeem Altaf, Round Rock, TX (US); Moez Kamel, Saint Maur des Fosses (FR); Grant Douglas Miller, Anthem, AZ (US); Selvi John, Bangalore (IN); Santosh Rajashekar, Bangalore (IN)

(21) Appl. No.: 19/009,743

(22) Filed: Jan. 3, 2025

(51) Int. Cl. G05D 1/693; B64G 1/24; B64G 3/00; G06N 20/00

(52) U.S. Cl. CPC G05D 1/693; B64G 1/244; B64G 3/00; G06N 20/00

(57) ABSTRACT

A method, according to one embodiment, includes obtaining satellite data associated with a plurality of satellites, and using a predetermined algorithm to condition the satellite data for an AI model, where trust scores are generated for different portions of the satellite data based on predetermined attributes. The method further includes causing the AI model to analyze the conditioned satellite data and, based on the analysis, predict collision events for the satellites based on the trust scores. The predicted collision events are prevented from occurring. A computer program product, according to another embodiment, includes one or more computer-readable storage media, and program instructions stored on the one or more storage media to perform the foregoing method.

### BACKGROUND

The present invention relates to artificial intelligence (AI) models, and more specifically, this invention relates to using AI models for analyzing satellites.

Satellites are fabricated and then caused to orbit Earth's surface. There are many different types of satellites, e.g., low Earth orbit (LEO) satellites, Medium Earth orbit (MEO) satellites, High Earth orbit (HEO) satellites, etc. These satellites are used for different purposes including, but are not limited to, weather forecasting, communications, navigations, arial camera feeds, etc.

### SUMMARY

A method, according to one embodiment, includes obtaining satellite data associated with a plurality of satellites, and using a predetermined algorithm to condition the satellite data for an AI model, where trust scores are generated for different portions of the satellite data based on predetermined attributes. The method further includes causing the AI model to analyze the conditioned satellite data and, based on the analysis, predict collision events for the satellites based on the trust scores. The predicted collision events are prevented from occurring.

A computer program product, according to another embodiment, includes one or more computer-readable storage media, and program instructions stored on the one or more storage media to perform the foregoing method.

A computer system, according to another embodiment, includes a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using AI models to prevent satellite collisions.

In one general embodiment, a method includes obtaining satellite data associated with a plurality of satellites, and using a predetermined algorithm to condition the satellite data for an AI model, where trust scores are generated for different portions of the satellite data based on predetermined attributes. The method further includes causing the AI model to analyze the conditioned satellite data and, based on the analysis, predict collision events for the satellites based on the trust scores. The predicted collision events are prevented from occurring.

In another general embodiment, a computer program product includes one or more computer-readable storage media, and program instructions stored on the one or more storage media to perform the foregoing method.

In another general embodiment, a computer system includes a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as collision event prevention code of block 150 for using AI models to prevent satellite collisions. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

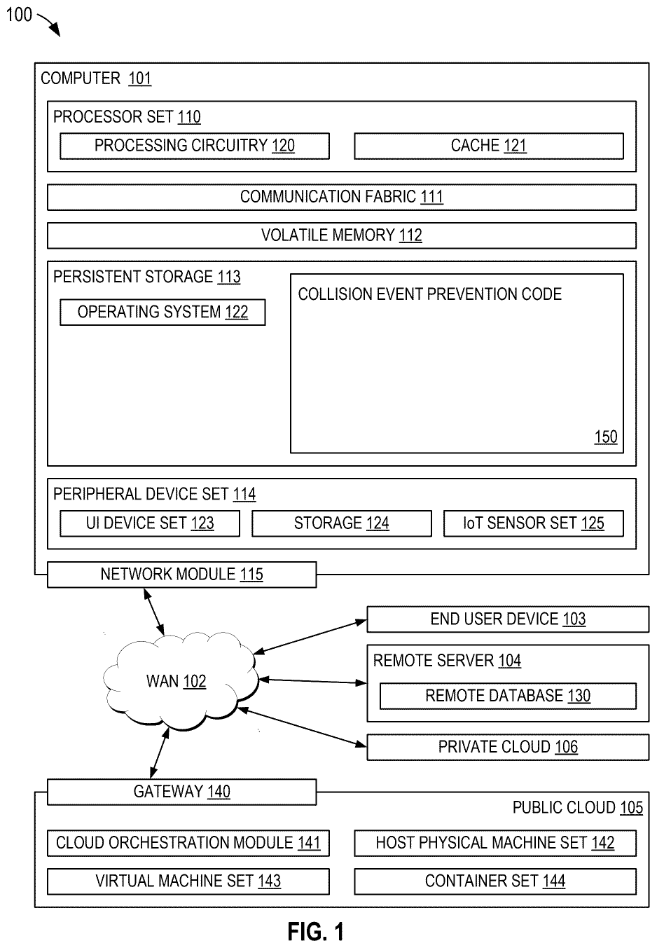

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, satellites are fabricated and then caused to orbit Earth's surface. There are many different types of satellites, e.g., low Earth orbit (LEO) satellites, Medium Earth orbit (MEO) satellites, High Earth orbit (HEO) satellites, etc. These satellites are used for different purposes including, but are not limited to, weather forecasting, communications, navigations, arial camera feeds, etc.

Corporations and governments that own satellites track their satellites while using the satellite. Other many other public and private platforms also attempt to and/or claim to possess information about these satellites, e.g., such as their location. For example, some applications that are not associated with ownership of satellites sometimes offer features that allege the location of the satellites. However, among these applications, the information reported about the satellites is often conflicting, e.g., different reported statuses and/or positions. Furthermore, the information offered by these applications often reports different data than information offered by the corporations and/or governments that own satellites.

The issues stated above result in a lack in efficiency of this data and prevents the data from being used to predict collisions between satellites. This is because there is no single source of truth when considering satellite data. The lack of efficiency occurs based on inaccurate data being transmitted among networks by computer components of the networks. Accordingly, there is a longstanding unmet need for a framework to consolidate satellite information (and/or other orbital elements) from different data sources (public and/or private) and use the information to accurately and efficiently predict collision events.

In sharp contrast to the deficiencies described above, techniques of embodiments and approaches described herein meet the longstanding unmet need mentioned above by implementing a crowdsourcing approach, by enabling a framework to received data from variety of sources, applying weights to the data (determining trust values for respective portions of the data) based on predetermined attributes (data frequency, data quality, source reputation and data integrity). More specifically, AI model(s) are used to perform modeling and predictions for meeting this longstanding unmet need, as well as causing, e.g., determining and issuing instructions for avoidance solutions, the collisions from occurring.

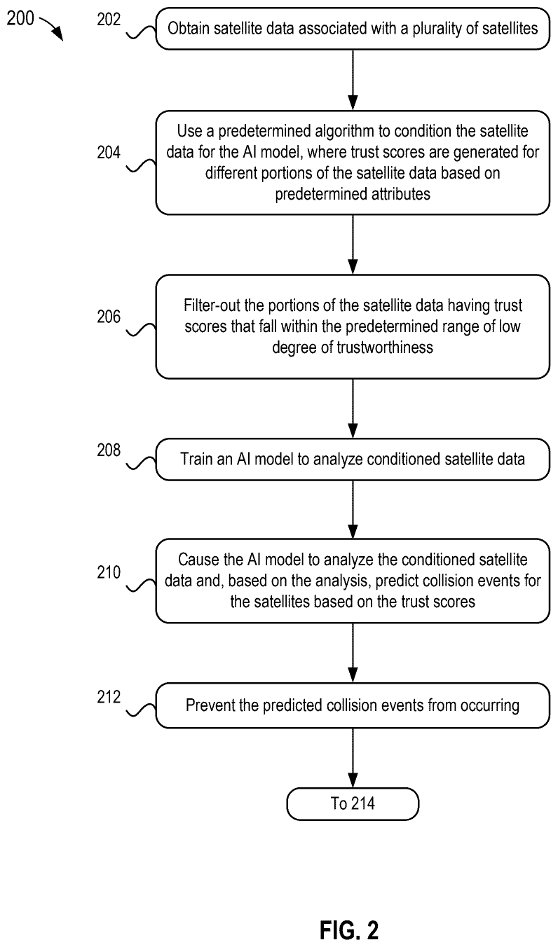

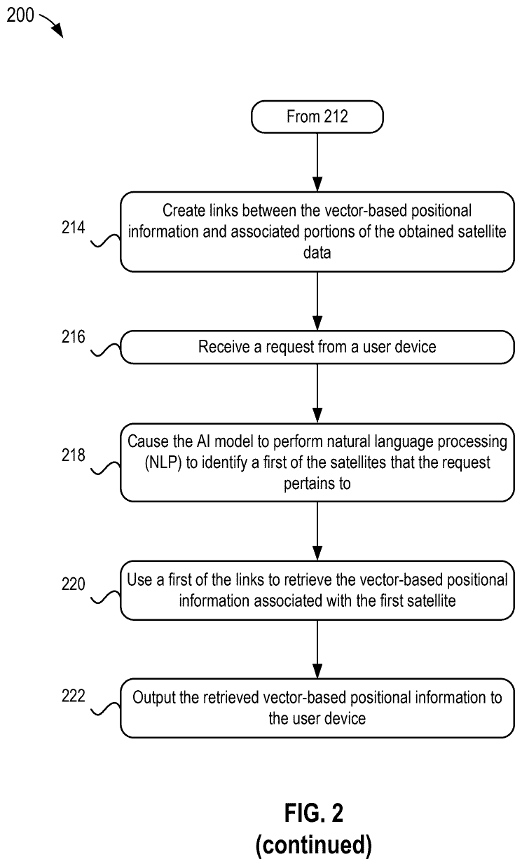

Now referring to FIG. 2, a flowchart of a method 200 is shown according to one embodiment. The method 200 may be performed in accordance with aspects of the present invention in any of the environments depicted in FIGS. 1-4, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It should be prefaced the various techniques of embodiments and approaches herein of refer to operations being performed with respect to satellites. In some approaches, these operations may additionally and/or alternatively be performed with respect to other types of space-based technology, e.g., spaceships, space stations, space vehicles, rockets, etc. Furthermore, the collision events described herein may be predicted with respect to any combination of the satellites and/or other types of space-based technology mentioned above and/or celestial bodies (such as asteroids, space junk, planets, gravitational pulls, etc.).

Operation 202 includes obtaining satellite data associated with a plurality of satellites. In some preferred approaches, the satellite includes Norad IDs and/or two line elements (TLE) for satellite positioning and may additionally and/or alternatively include ephemeris for celestial bodies positioning (e.g., such as for approaches in which the operations described herein are performed with respect to asteroids). The satellite data may, in some approaches, include, e.g., identifiers (IDs) of satellites, predetermined metrics associated with the satellites, software versions being run on the different satellites, etc. In some approaches the predetermined metrics associated with the satellites include, e.g., a current altitude of a satellite, a trajectory of a satellite, orbital plane information of a satellite, an average moving speed of a satellite, an orbital path of a satellite, a shape of a satellite's orbital path, etc. In some other approaches, the satellite data may specify a connectivity status of a satellite, e.g., other satellites that the satellite is in communication with, ground stations that attest to communicating with the satellite within a predetermined amount of time from a current time, timestamp information that details when communications occurred, etc.

The satellite data is, in some preferred approaches, obtained from a plurality of different sources. In some preferred approaches, the satellite data is obtained from a user device of a company, a user device of a person that owns the satellite, a user device of a government that owns the satellite, etc. In some other approaches, the sources may additionally and/or alternatively include a company that manages an application and/or service platform that attests to having at least some of the satellite data, e.g., such as a satellite tracking application that offers graphical representations (on a display of a user device running the application) of satellite locations and/or other satellite data. The sources may additionally and/or alternatively include a forum where devices, associated with user accounts, are able to upload information about satellites. The sources may additionally and/or alternatively include sources including, but not limited to, logs of web crawlers that are programmed to search the web for predetermined types of satellite data, chat logs (provided that user permission is gained to analyze and extract information from participants of the chat logs), telescope feeds, etc. It should be noted that in some approaches, the sources include private sources, while in some other approaches, the sources may additionally and/or alternatively include public sources. For context, some of the sources from which the satellite data is collected may be relatively more trustworthy than other sources from which the satellite data is collected. Any data obtained from trustworthy sources are prioritized over other data obtained from untrustworthy sources (as will be described in further detail below with respect to the filtering and trust scores).

Operation 204 includes using a predetermined algorithm to condition the satellite data for an AI model. The predetermined algorithm may, in some approaches, also be referred to as a “CosmicTrust” algorithm herein. In some approaches, trust scores are generated (by the predetermined algorithm as a result of the conditioning) for different portions of the satellite data based on predetermined attributes. For context, the conditioning of the satellite data involves an ingestion of the satellite data by the predetermined algorithm and based on the ingestion, a preparation of the data (e.g., ingestion, curation, cleansing, weighting, etc.) in order to normalize the satellite data for analysis by an AI model.

In some approaches, using the predetermined algorithm to condition the satellite data includes performing machine leaning techniques to perform cause clustering of the satellite data into different respective clusters, e.g., using one or more machine learning algorithms (Classification and Clustering) of a type that would become apparent to one of ordinary skill after reading the descriptions herein. These clusters may also be referred to as “orbital elements attributes” that are fed into the CosmicTrust algorithm to determine trust values for the satellite data. In some approaches, one of these clusters may, for example, include positional-type satellite data, e.g., trajectory information, average speed information, etc. In one or more of such approaches, using the predetermined algorithm to condition the satellite data includes using the obtained satellite data (and more specifically satellite data of a cluster containing positional-type satellite data) to determine vector-based positional information for the satellites. In some approaches, the determined vector-based positional information is incorporated (stored and dynamically updated) into a vector database. However, the predetermined algorithm is, in some preferred approaches, further caused to condition the satellite data by generating respective trust scores for the different clusters of data.

In order to generate respective trust scores for the different portions (clusters, portions of raw data from different sources, etc.) of data, the predetermined algorithm may be configured to analyze and rate the level of efficiency that the satellite data respectively adheres to the predetermined attributes. In some preferred approaches, a first of the predetermined attributes includes a reputation of a source from which one or more of the portions of the satellite data are obtained (also referred to herein as a “source reputation”). For context, in order to generate a trust score for a first portion of the satellite data with respect to a reputation of a source from which the first portion of the satellite data is obtained, the predetermined algorithm may consider a historical reputation and reliability of the source. Sources of satellite data may, in some approaches, be assigned a relatively greater trust score weight and/or value in response to a determination that the sources are verified by predetermined platforms, approved by predetermined governing bodies, have greater than a predetermined length of existence, employ more than a predetermined number of people, etc. Illustrative examples of established sources that, in some approaches, be assigned a relatively greater trust score weight and/or value include North American Aerospace Defense Command (NORAD) or other reputable satellite tracking websites which are predetermined to more likely provide accurate TLE information. In contrast, sources of satellite data may, in some approaches, be assigned a relatively lesser trust score weight and/or value in response to a determination that the sources are not verified by predetermined platforms, are flagged by predetermined platforms, not approved and/or flagged by predetermined governing bodies, do not have greater than a predetermined length of existence, do not employ more than a predetermined number of people, etc.

In some preferred approaches, the predetermined attributes may additionally and/or alternatively include a quality of the satellite data from which one or more of the portions of the satellite data are obtained (also referred to herein as a “data quality”). For context, in order to generate a trust score for a data quality of a first portion of the satellite, the predetermined algorithm may consider orbital elements attributes (and/or other parameters) and look for consistency in the considered elements and/or parameters. For example, outliers in the satellite data may, in some approaches, be determined to be inaccuracies, where associated data from the other sources all otherwise match (or at least a majority of the associated data from the other sources otherwise match). In some other approaches, satellite data quality may be based on an extend of specifics that the satellite data includes, e.g., portions of the satellite data determined to have relatively more detail (for example more trajectory and altitude specifics over a period of time may represent consistency) may be assigned a relatively greater trust score weight and/or value while portions of the satellite data determined to have relatively less detail (for example only one instance of attested moving speed of a satellite may not represent consistency) may be assigned a relatively lesser trust score weight and/or value.

In some other preferred approaches, the predetermined attributes may additionally and/or alternatively include a frequency at which the portions of the satellite data are obtained (also referred to herein as a “data frequency”). More specifically, for a first type of a given portion of data, e.g., for satellite data received from a first of the sources regarding an orbital path of a first of the satellites, the data frequency may refer to a frequency that the satellite data is received. In some approaches, the satellite data may be a first instance of satellite data received from the source and/or regarding the first of the satellites. In this case, no frequency may be determined, and the satellite data may be determined to be a new type of satellite data. In some other approaches in which more than one instance of the satellite data is received over time for a given portion of the satellite data, e.g., such as updates obtained over time from a first source of an average moving speed of a first satellite, the frequency may be determined and compared with other determined frequencies (e.g., such as updates obtained over time from a second source of an average moving speed of a second satellite). Portions of data determined to be received from a source in a periodic manner, e.g., consistently, and/or a predetermined number of times within a predetermined sample period may be assigned a relatively greater trust score weight and/or value. In contrast, in some other approaches, first instances of data may be assigned, at least initially, a relatively lowest trust score weight and/or value. In some other approaches, portions of the satellite data determined to be received from a source in a non-periodic manner, e.g., inconsistently, and/or less than a predetermined number of times within a predetermined sample period may be assigned a relatively lower trust score weight and/or value.

In some other preferred approaches, the predetermined attributes may additionally and/or alternatively include a data integrity of the satellite data. For context, the data integrity of the satellite data refers to and tests for data integrity of the satellite data. For context, a data integrity of the satellite data may, in some approaches, refer to whether data, over time, is free of variance. In one or more of these approaches, the data integrity may be determined with respect to a checksum verification as a sub-element of data integrity, in addition to and/or alternative to other predetermined sub-elements, e.g., variance of a predetermined data metric over time, a presence of datasets and/or orbital elements, etc.

In some other approaches, a data integrity of the satellite data may additionally and/or alternatively be based on a plurality of sub-factors. For example, a first of the factors may be based on a consistency of the values present in the satellite data, e.g., whether the values have greater than a predetermined threshold of variance over time. A second of the sub-factors is, in some approaches, based on a data integrity, which includes a simple calculation of the TLE. More specifically, in some approaches, a data integrity performed based on a calculation of the TLE may include first examining the formatting and data integrity in the TLE data. TLEs determined to be formatted with correct data integrity elements (e.g., checksum verification of a predetermined sub-element) are indicative of a relatively careful and accurate data generation process and may therefore be assigned a relatively greater trust score weight and/or value. In contrast, TLEs determined to be formatted with incorrect data integrity elements are indicative of a relatively unstable and inaccurate data generation process and may therefore be assigned a relatively lower trust score weight and/or value. In some approaches, a third of the sub-factors includes completeness. For context, completeness refers to whether satellite data includes a presence of an entire data set of predetermined orbital elements, e.g., a plurality of predetermined orbital elements are present in the obtained satellite data.

Each of the sub-factors described above may be dynamically assigned different weights in a calculation of the trust score weight and/or value. In some approaches, sub-scores and/or sub-values are calculated for each of the sub-factors and then a final trust score weight and/or value may be calculated for the data integrity (as a sum, an average, etc.) using each of the sub-scores and/or sub-values determined for the sub-factors (while applying the dynamically assigned different weights in the calculation).

In some approaches, a plurality of the trust scores for different portions of the satellite data received from the same source may be averaged and/or combined using a predetermined formula that incorporates the determined weights in order to determine a degree of trustworthiness of the source from which the satellite data is received. In some other approaches, one or more of the trust scores are kept and processed independently of the other trust scores. The trust scores are, in some approaches, characterized according to a predetermined scale of trustworthiness. For example, assuming that a plurality of different predetermined ranges exist, the different trust scores may fall within one of the predetermined ranges. For example, a first of these ranges may include a low degree of trustworthiness, a second of these ranges may include medium degree of trustworthiness, and a third of these ranges may include a high degree of trustworthiness. However, the number of different predetermined ranges may depend on the approach.

Operation 206 includes optionally filtering-out at least some of the satellite data in order to preserve processing potential and reduce an amount of computational operations performed. For context, in some approaches, the relatively least trustworthy data is preferably filtered out to prevent the introduction of errors into computational operations that use the satellite data. Accordingly, in one or more of such approaches, the portions of the satellite data having trust scores that fall within the predetermined range of low degree of trustworthiness are filtered-out from the conditioned satellite data (the conditioned satellite data that is thereafter eventually analyzed by the AI model). This filtering reduces a processing load of the AI model and increases an accuracy of the predicted collision events by the AI model as will be described in greater detail elsewhere herein. In some approaches, once the trust scores are determined and/or the determined trust scores are associated with one of the predetermined ranges of trustworthiness and/or filtering is optionally performed on the satellite data, the satellite data may be sufficiently conditioned for an AI model to analyze. Various approaches below preface illustrative operations for training an AI model to analyze the conditioned data described herein.

In contrast to some approaches described above, in some approaches, the relatively least trustworthy data is not filtered out in order to allow the data conditioned by the predetermined algorithm to include satellite data with a relatively broad scope of trustworthiness, e.g., in order to provide conditioned data that falls into each of the different predetermined ranges.

Operation 208 includes training the AI model to analyze the conditioned satellite data. In some approaches training the AI model to analyze the conditioned satellite data includes causing the AI model to ingest a training set of data. The AI may be instructed to prioritize data of the training set of data that has relatively greater trust scores over data of the training set of data that has relatively lower trust scores (if available). In some approaches, the AI model is caused, e.g., instructed, to, during the training, filter out a portion of the training set of data based on the predetermined attributes, e.g., filter out untrustworthy training satellite data having less than a predetermined trust score. In response to a determination that the AI model makes a correct filtering, e.g., filters untrustworthy data out from consideration and prioritizes trustworthy data, reward based feedback is provided to the AI model. The AI model may furthermore be caused to, based on the ingestion, make guesses as to collision events between satellites of the training set of data (where answers as to which collisions are actually likely to occur are withheld from the AI model). In response to a determination that the AI model makes a correct guess, reward based feedback is provided to the AI model. In contrast, in response to a determination that the AI model makes an incorrect guess, the AI model is tuned using techniques that would become apparent to one of ordinary skill in the art after reading the descriptions herein. In response to a determination, during the training, that the AI model has exceeded a predetermined threshold of accuracy, the AI model is deployed. In other words, training may be performed until a determination is made that the AI model is trained and ready to be deployed.

Operation 210 includes causing the AI model to analyze the conditioned satellite data and, based on the analysis, predict potential collision events for the satellites based on the trust scores. In some approaches, analysis of the conditioned satellite data by the AI model may include establishing a predetermined amount of trusted data and classifying portions of data of a remainder of the data as being potentially trustworthy or untrustworthy. More specifically, in some approaches, depending on what satellite is obtained and/or survives the conditioning, a first type of the satellite data that is used to predict potential collision events may have a trust score that falls within the predetermined range of low degree of trustworthiness. In such cases, the AI model may rely on such data, or alternatively output a request for supplemental data from other sources. This satellite data having a trust score that falls within the predetermined range of low degree of trustworthiness is preferably excluded while establishing the predetermined amount of trusted data if possible (provided that other relatively more trustworthy data is included in the conditioned satellite data). Satellite data identified as trustworthy during this process is preferably used to predict the potential collision events.

Potential collision events may be predicted using techniques that would become apparent to one of ordinary skill in the art after reading the description herein. Moreover, in some approaches, potential collision events may be predicted using positional forecasting techniques that would become apparent to one of ordinary skill in the art after reading the description herein. Generally, in some approaches, these techniques involve using values of satellite data identified as trustworthy to predict whether a position of any satellite will, at any time, come within a predetermined proximity (less than a longest spatial length of the satellite) from another of the satellites.

In some approaches, the potential collision events may be predicted using vector-based positional information. Accordingly, in these approaches, the AI model may access the vector-based positional information from the vector database for performing the analysis of the conditioned satellite data. In some approaches, specialized indexing techniques may be used with the vector database. For example, these techniques may include one or more of k-d trees, ball trees, locality-sensitive hashing (LSH), etc., to enable relatively fast and efficient search operations (by instructing the AI model) over large datasets of vectors. Similarity search techniques may additionally and/or alternatively be performed in method 200 for using the vector database. For example, given a query vector, a similarity search operation may be performed within the database for find the closest vectors in the vector dataset based on a chosen distance metric (e.g., such as Euclidean distance or cosine similarity). The vector database offers beneficial high-dimensional support. This is because vector databases may be built to handle relatively high-dimensional data effectively, where the number of dimensions can be much larger than traditional databases can handle. Scalability is also enabled as a result of using the vector database described herein. This is because many vector databases are designed to scale horizontally, allowing for efficient distributed storage and querying across multiple nodes or clusters. Support for embeddings is also enabled. Vector databases may be particularly useful in applications involving natural language processing (NLP) and computer vision, where embeddings from deep learning models are used to represent textual or visual information (note that use of NPL is described elsewhere below).

To access the vector-based positional information from the vector database for performing the analysis of the conditioned satellite data, in some approaches, the AI model may use retrieval-augmented generation (RAG). For RAG, external metadata (e.g. data from an online index of objects launched into outer space) may be injected into the AI model to add relatively more accuracy and efficiency to the prediction of the potential collision events. With respect to use of the vector database and RAG in the analysis of the conditioned satellite data, the AI model may utilize the vector database for performing efficient search operations over relatively large datasets of vectors, and RAG for iteratively improving an accuracy of these searches, as well as mitigating biases in satellite collision predictions. In order to enable these improvements, key features of the RAG include contextual consistency in that the retrieval step helps ensure that the generated output (information detailing specifics of the potential collision events) is contextually relevant and consistent with the provided input and the retrieved context. By retrieving relevant information from a database, RAG provides relatively more accurate responses, especially in information retrieval or question-answering tasks (e.g., described elsewhere below in operation 216). The retrieval mechanism also allows developers to control the scope of the generated responses by choosing an appropriate retrieval database or providing specific queries. As mentioned above, generation bias is also relatively reduced by using retrieved context (RAG can help mitigate some of the generation biases commonly observed in pure generative models).

An accuracy of the AI model is, in some approaches, preferably refined over time. For example, operations of method 200, in some approaches, include training the AI model, validating an accuracy of the AI model before deployment, periodically reviewing whether predictions by the AI model are accurate, and re-iterating training and/or reward based feedback over time.

Operation 212 includes preventing the predicted collision events from occurring. It should be noted that satellites are relatively very expensive to produce and set into orbit, and therefore the AI model is preferably instructed to predict collisions with sufficient lead time to allow for timely intervention. Moreover, because the satellite data that is considered trustworthy over time may change over time, any change in position or a vector is preferably accompanied by consideration of a new trajectory for accurately considering potential collisions in the future.

In order to prevent the predicted collision events from occurring, in some approaches, an action is performed. In some approaches, the action includes a warning being output to at least one of the satellites involved in the predicted collision events. In some other approaches, the action includes causing the AI model to calculate a thrust force for a first of the satellites involved in the predicted collision events to apply. This thrust force may be provided to the satellite. For example, in some approaches, the action additionally and/or alternatively includes issuing an instruction for causing the first satellite to apply the calculated thrust force.

User device interaction features may additionally and/or alternatively be enabled in some operations of method 200. For context, these user device interaction features, in some approaches, include a working mechanism that allows user inputs while interacting with platform. (e.g., asking about satellite information, collision rate, etc.) to be analyzed by leveraging NLP. In order to enable these features, in some approaches, links may be created between the vector-based positional information and associated portions of the obtained satellite data, e.g., see operation 214. These links may then be used to fulfill user requests, in some approaches. For example, operation 216 includes receiving a request from a user device. The request may be processed to determine how to fulfill the request. For example, in some approaches, method 200 includes causing the AI model to perform NLP to identify a first of the satellites that the request pertains to, e.g., see operation 218. Illustrative examples of information that may be requested include attributes associated with the satellites, e.g., speed, rate of collision, etc.

At least one of the links, e.g., a first of the links, may be used to retrieve the vector-based positional information associated with the first satellite (in order arrange fulfillment of the request), e.g., see operation 220. Operation 222 includes outputting the retrieved vector-based positional information to the user device. In some approaches, reply notifications (sent in response to receiving a request) may be customized according to user preferences. For example, reply notifications may detail at least some predetermined attributes for satellites associated with received requests. Furthermore, the reply may include notifications of suggested actions, e.g., “move your satellite to position A.”

Some performance benefits enabled by the techniques of method 200 are detailed elsewhere above. Further benefits are described below.

One benefit enabled by the techniques described herein includes the longstanding need for timely and accurate satellite collision being met. Prior to the offerings of the techniques described herein, there has been no standardized framework to assimilate and analyze information effectively to detect potential collisions involving laser-equipped satellites. Accordingly, the techniques described herein fill this gap and create a comprehensive system to address this challenge. Specifically, these techniques address the lack of a standardized framework for assimilating and analyzing satellite and celestial body data efficiently to predict collisions, filling a crucial gap in the field of satellite technology.

Another benefit enabled by the techniques described herein involves efficiency and accuracy of collision prediction. This is because the techniques described herein offer a robust detection, triaging, and response framework that enhances the efficiency and accuracy of collision risk identification. Developing these innovative tools and techniques based on AI and data assimilation significantly improves the precision and timeliness of collision risk assessments.

These benefits also enable benefits in the technical field of safety and regulation compliance. For context, the number of satellites in space increases each year. Accordingly, the techniques described herein may be scaled out to ensure the safety of space operations and to define the information and protocols for regulatory bodies to manage and mitigate collision risks effectively.

Benefits with the technical field of data integration and correlation are also enabled by the techniques described herein. Specifically, in some approaches, these techniques integrate data from multiple open-source resources and establish correlations between satellite identifiers like Norad ID. This data integration and correlation significantly enhances the ability to predict and prevent collisions.

Furthermore, with respect to adherence to standards, the techniques described herein address critical issues related to data ingestion, data quality, and model training, adhering to established standards like Norad ID and TLE sets to ensure compliance with industry norms. In doing so, crowdsourcing and collaboration is leveraged to gather a relatively wide range of data sources.

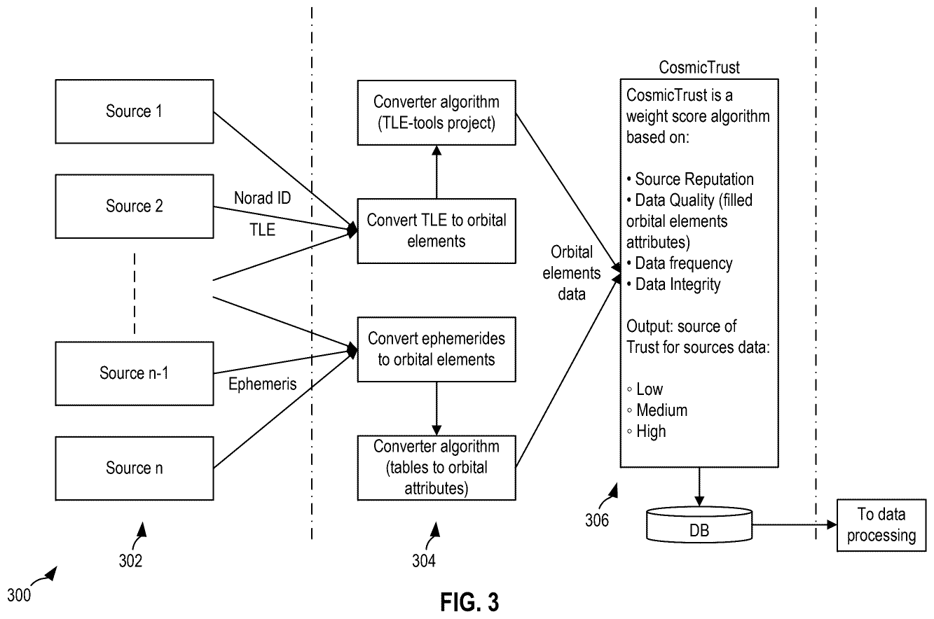

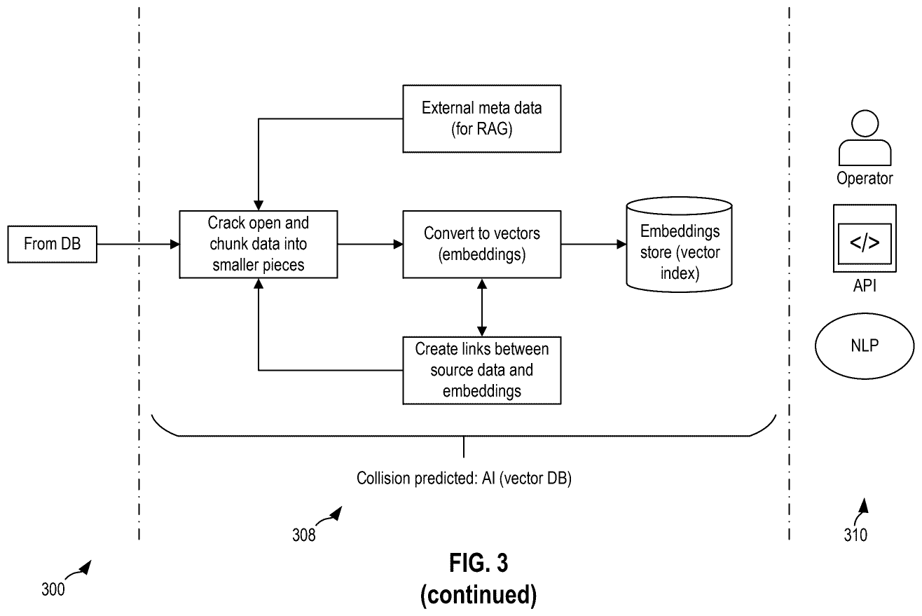

Now referring to FIG. 3, a flowchart of a method 300 is shown according to one embodiment. The method 300 may be performed in accordance with aspects of the present invention in any of the environments depicted in FIGS. 1-4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 includes some operations that are similar to method 200, as well as some infrastructure components to show where satellite data is obtained from, stored in, and output to.

Satellite data is collected from a plurality of different sources in operation 302. In some approaches, this satellite data includes a plurality of different types of data, e.g., see Norad Id, TLE, etc. In operation 304, algorithms are used to convert portions of the data may be converted to predetermined types of data, e.g., orbital elements. Thereafter, these orbital elements are processed by the CosmicTrust algorithm using techniques described elsewhere herein, e.g., see operation 306. An output of the CosmicTrust algorithm may include trust scores that fall into predetermined ranges, e.g., see Low, Medium and High, which characterize a trustworthiness of the satellite data. These outputs may be stored in a predetermined database, e.g., see DB.

Data processing is performed in operation 308. Specifically, potential collision events are predicted by an AI model using techniques described elsewhere herein. Furthermore, operations may be performed to enable interaction with user devices 310, e.g., see create links, storing embeddings, etc.

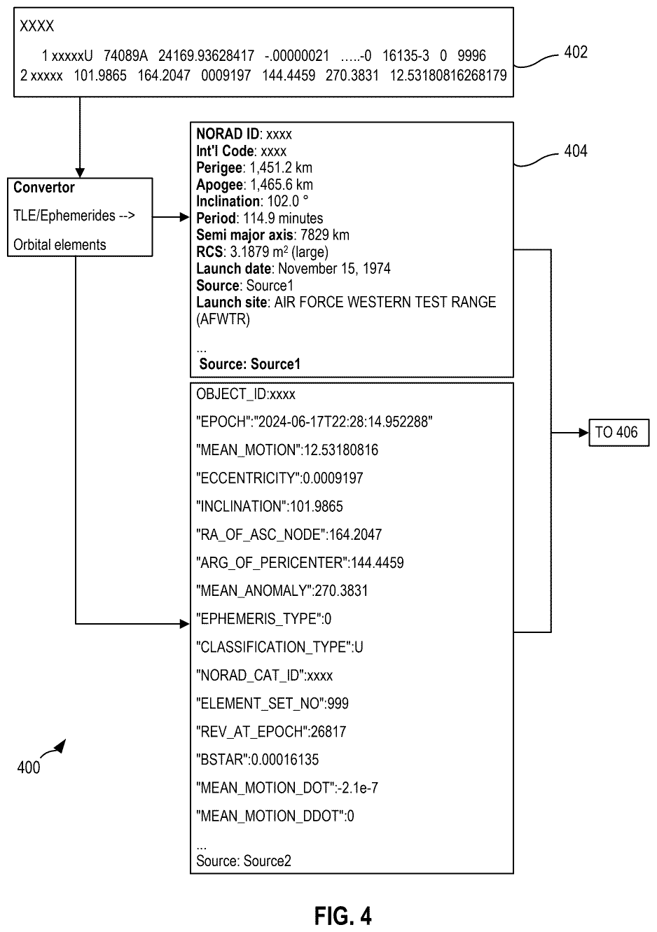

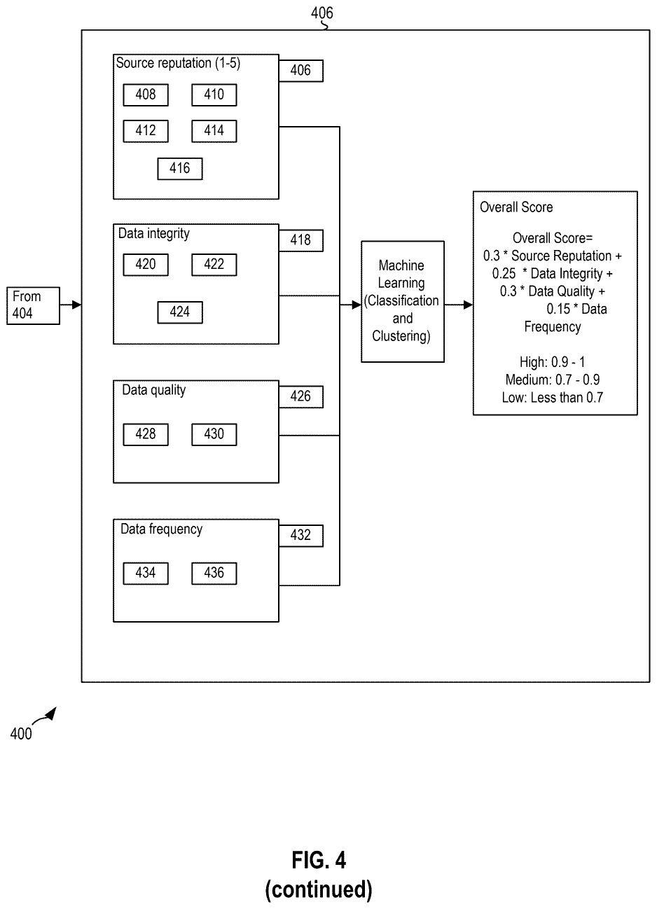

Now referring to FIG. 4, a flowchart of a method 400 is shown according to one embodiment. The method 400 may be performed in accordance with aspects of the present invention in any of the environments depicted in FIGS. 1-4, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 400 includes some operations that are similar to method 200 with respect to obtaining satellite data and conditioning the satellite data for an AI model to analyze.

Operation 402 includes obtaining satellite data. In some approaches, the obtained satellite data includes raw data and/or metadata that may be converted, e.g., see convertor component, to a plurality of different types of data 404, e.g., see NORAD ID, INT'l Code, Perigee, etc.

The satellite data is then conditioned by a CosmicTrust algorithm, where trust scores are generated for different portions of the satellite data based on predetermined attributes. For example, a first of the predetermined attributes includes source reputation, which may be based on predetermined principles 406, and use satellite data including government and military agency data 408, academic and research institution data 410, other data 412, commercial operator data 414 and satellite tracking service data 416, to generate the trust score.

A second of the predetermined attributes includes data integrity, which may be based on predetermined best practices 418, and use satellite data including consistency data 420, data integrity data 422, and completeness data 424 to generate the trust score. A third of the predetermined attributes includes data quality, which may be based on predetermined NIST guidelines 426, and use satellite data including accuracy data 428 (a difference between reported and actual positions) and precision data 430 (a consistency of the data over multiple observations in a predetermined historical period) to generate the trust score. A fourth of the predetermined attributes includes data frequency, which may be based on predetermined guidelines 432, and use satellite data including regularity data 434 (data updates) and timeliness data 436 (a delay between the different timestamp in the satellite data based on data refreshes) to generate the trust score. Clustering of the satellite data may be performed, e.g., using machine learning (Classification and Clustering), and an overall trust score may be generated based on each of the different trust scores. The overall trust score may fall within a predetermined range, e.g., see High: 0.9-1, Medium: 0.7-0.9 and Low: Less than 0.7.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining satellite data associated with a plurality of satellites;
using a predetermined algorithm to condition the satellite data for an artificial intelligence (AI) model, wherein trust scores are generated for different portions of the satellite data based on predetermined attributes;
causing the AI model to analyze the conditioned satellite data and, based on the analysis, predict collision events for the satellites based on the trust scores; and
preventing the predicted collision events from occurring.

2. The method of claim 1, wherein the using the predetermined algorithm to condition the satellite data comprises:
using the obtained satellite data to determine vector-based positional information for the satellites; and
incorporating the determined vector-based positional information into a vector database, wherein the AI model accesses the vector-based positional information from the vector database for performing the analysis of the conditioned satellite data.

3. The method of claim 2, wherein the AI model uses retrieval-augmented generation (RAG) for accessing the vector-based positional information from the vector database for performing the analysis of the conditioned satellite data.

4. The method of claim 2, further comprising:
creating links between the vector-based positional information and associated portions of the obtained satellite data;
receiving a request from a user device;
causing the AI model to perform natural language processing (NLP) to identify a first of the satellites that the request pertains to;
using a first of the links to retrieve the vector-based positional information associated with the first satellite; and
outputting the retrieved vector-based positional information to the user device.

5. The method of claim 1, wherein the preventing the predicted collision events from occurring comprises:
performing an action selected from the group consisting of: outputting a warning to at least one of the satellites involved in the predicted collision events, calculating a thrust force for a first of the satellites involved in the predicted collision events to apply, and issuing an instruction for causing the first satellite to apply the calculated thrust force.

6. The method of claim 1, wherein the predetermined attributes are selected from the group consisting of: reputation of a source from which the different portions of the satellite data are obtained, a quality of the satellite data, a frequency at which the satellite data is obtained, and a data integrity of the satellite data.

7. The method of claim 1, further comprising:
training the AI model to analyze the conditioned satellite data, wherein training the AI model to analyze the conditioned satellite data comprises:
causing the AI model to ingest a training set of data,
causing the AI model to filter out a portion of the training set of data based on the predetermined attributes, and
in response to a determination that the AI model makes a correct guess, providing reward based feedback to the AI model; and
in response to a determination, during the training, that the AI model has exceeded a predetermined threshold of accuracy, deploying the AI model.

8. The method of claim 1, wherein the trust scores fall within predetermined ranges selected from the group consisting of: low degree of trustworthiness, medium degree of trustworthiness, and high degree of trustworthiness, and further comprising:
filtering-out the portions of the satellite data having trust scores that fall within the predetermined range of low degree of trustworthiness from the conditioned satellite data analyzed by the AI model.

9. A computer program product comprising:
one or more computer-readable storage media; and
program instructions stored on the one or more storage media to perform operations comprising:
obtaining satellite data associated with a plurality of satellites;
using a predetermined algorithm to condition the satellite data for an artificial intelligence (AI) model, wherein trust scores are generated for different portions of the satellite data based on predetermined attributes;
causing the AI model to analyze the conditioned satellite data and, based on the analysis, predict collision events for the satellites based on the trust scores; and
preventing the predicted collision events from occurring.

10. The computer program product of claim 9, wherein the using the predetermined algorithm to condition the satellite data comprises:
using the obtained satellite data to determine vector-based positional information for the satellites; and
incorporating the determined vector-based positional information into a vector database, wherein the AI model accesses the vector-based positional information from the vector database for performing the analysis of the conditioned satellite data.

11. The computer program product of claim 10, wherein the AI model uses retrieval-augmented generation (RAG) for accessing the vector-based positional information from the vector database for performing the analysis of the conditioned satellite data.

12. The computer program product of claim 10, wherein the operations further comprise:
creating links between the vector-based positional information and associated portions of the obtained satellite data;
receiving a request from a user device;
causing the AI model to perform natural language processing (NLP) to identify a first of the satellites that the request pertains to;
using a first of the links to retrieve the vector-based positional information associated with the first satellite; and
outputting the retrieved vector-based positional information to the user device.

13. The computer program product of claim 9, wherein the preventing the predicted collision events from occurring comprises:
performing an action selected from the group consisting of: outputting a warning to at least one of the satellites involved in the predicted collision events, calculating a thrust force for a first of the satellites involved in the predicted collision events to apply, and issuing an instruction for causing the first satellite to apply the calculated thrust force.

14. The computer program product of claim 9, wherein the predetermined attributes are selected from the group consisting of: reputation of a source from which the different portions of the satellite data are obtained, a quality of the satellite data, a frequency at which the satellite data is obtained, and a data integrity of the satellite data.

15. The computer program product of claim 9, wherein the operations further comprise:
training the AI model to analyze the conditioned satellite data, wherein training the AI model to analyze the conditioned satellite data comprises:
causing the AI model to ingest a training set of data,
causing the AI model to filter out a portion of the training set of data based on the predetermined attributes, and
in response to a determination that the AI model makes a correct guess, providing reward based feedback to the AI model; and
in response to a determination, during the training, that the AI model has exceeded a predetermined threshold of accuracy, deploying the AI model.

16. The computer program product of claim 9, wherein the trust scores fall within predetermined ranges selected from the group consisting of: low degree of trustworthiness, medium degree of trustworthiness, and high degree of trustworthiness, and further comprising:
filtering-out the portions of the satellite data having trust scores that fall within the predetermined range of low degree of trustworthiness from the conditioned satellite data analyzed by the AI model.

17. A computer system comprising:
a processor set;
one or more computer-readable storage media; and
program instructions stored on the one or more storage media to cause the processor set to perform operations comprising:
obtaining satellite data associated with a plurality of satellites;
using a predetermined algorithm to condition the satellite data for an artificial intelligence (AI) model, wherein trust scores are generated for different portions of the satellite data based on predetermined attributes;
causing the AI model to analyze the conditioned satellite data and, based on the analysis, predict collision events for the satellites based on the trust scores; and
preventing the predicted collision events from occurring.

18. The computer system of claim 17, wherein the using the predetermined algorithm to condition the satellite data comprises:
using the obtained satellite data to determine vector-based positional information for the satellites; and
incorporating the determined vector-based positional information into a vector database, wherein the AI model accesses the vector-based positional information from the vector database for performing the analysis of the conditioned satellite data.

19. The computer system of claim 17, wherein the preventing the predicted collision events from occurring comprises:
performing an action selected from the group consisting of: outputting a warning to at least one of the satellites involved in the predicted collision events, calculating a thrust force for a first of the satellites involved in the predicted collision events to apply, and issuing an instruction for causing the first satellite to apply the calculated thrust force.

20. The computer system of claim 17, wherein the predetermined attributes are selected from the group consisting of: reputation of a source from which the different portions of the satellite data are obtained, a quality of the satellite data, a frequency at which the satellite data is obtained, and a data integrity of the satellite data.
